(19) United States
(12) Patent Application Publication
(10) Pub. No.: US 2018/0217583 A1
(43) Pub. Date: Aug. 2, 2018

(54) EVENT-BASED COMMUNICATION IN MANUFACTURING ENVIRONMENT

(71) Applicant: Mentor Graphics Corporation, Wilsonville, OR (US)

(72) Inventors: Shaul Samara, Hufit (IL); William Daniel Bailey, Cork (IE); Igal Kaplan, Ez Efraim (IL); Bjarne Moeller, Risskov (DK)

(21) Appl. No.: 15/421,227

(22) Filed: Jan. 31, 2017

(51) Int. Cl. G05B 19/418; G08B 21/18

(52) U.S. Cl. CPC G05B 19/41855; G05B 2219/45026; G05B 2219/31151; G08B 21/187

(57) ABSTRACT

This application discloses a manufacturing system including equipment configured to manufacture at least a portion of an electronic system on a printed circuit board. The equipment can output status information corresponding to manufacturing operations for reception by an event device. The event device can maintain and update a state machine representation of the equipment based on the status information, determine an operational state of the equipment state machine representation, and generate an event message configured to identify the operational state of the equipment. The event device can receive an event subscription from a gateway device, and selectively transmit the event message towards the gateway device based on the event subscription. The event device can receive an equipment control signal from the gateway device, and prompt the equipment to perform an action in response to the equipment control signal.

### TECHNICAL FIELD

This application is generally related to electronic system assembly and, more specifically, to an event-based communication in manufacturing environment.

### BACKGROUND

Manufacturing of printed circuit board assemblies (PCBA) typically begins with a bare printed circuit board (PCB), which can be populated with electronic components utilizing a variety of technologies, such as through-hole technology, surface-mount technology (SMT), or the like. With through-hole technology, lead or pins of the electronic components can be placed in holes surrounded by conductive pads and then soldered in place. With surface-mount technology, the electronic components can be placed on the printed circuit board so that the pins line up with the conductive pads or lands on the surfaces of the printed circuit board and then soldered in place. The printed circuit boards populated with electronic components can be visually inspected, tested, and possibly reworked, to complete the manufacturing of the printed circuit board assemblies. The manufactured printed circuit board assemblies also may be combined with other manufactured electronic devices and/or mounted into a mechanical enclosure or product housing.

Many manufacturers of the printed circuit board assemblies typically automate at least part of their manufacturing process with assembly lines, for example, having one or more conveyors to route the printed circuit board to one or more assembly machines and/or verification machines in the manufacturing process. While automation of the manufacturing process can increase assembly throughput, the manufacturers often have to respond to bottlenecks in the assembly lines, such as an assembly machine running out of manufacturing materials, line blockage, or the like. Also, when the manufacturers identify defects in the printed circuit board assemblies, not only do the manufacturers have to initiate a time-intensive process of printed circuit board assembly rework, the manufacturers also may have to identify which of the assembly machines introduced the defects and then adjust one or more of the assembly machines.

Many of the assembly machines or verification machines in these assembly lines can have external interfaces to output information corresponding to their operations. These assembly machines or verification machines often use differing standards, protocols, and methodologies to output this information, often stifling attempts to collect and analyze operation of the assembly lines. Many of these assembly machines or verification machines also output information corresponding to their current operation, which can be interpreted differently based on previous operations performed by the assembly machines or verification machines.

### SUMMARY

This application discloses a manufacturing system including equipment configured to manufacture at least a portion of an electronic system on a printed circuit board. The equipment can output status information corresponding to manufacturing operations for reception by an event device. The event device can maintain and update a state machine representation of the equipment based on the status information, determine an operational state of the equipment state machine representation, and generate an event message configured to identify the operational state of the equipment. The event device can receive an event subscription from a gateway device, and selectively transmit the event message towards the gateway device based on the event subscription. The event device can receive an equipment control signal from the gateway device, and prompt the equipment to perform an action in response to the equipment control signal. Embodiments will be described below in greater detail.

### DESCRIPTION OF THE DRAWINGS

FIG. 1 illustrates an example of a manufacturing system for printed circuit board assembly according to various embodiments.

FIG. 2 illustrates an example of a portion of a manufacturing line in a printed circuit board assembly manufacturing system according to various embodiments.

FIGS. 3A and 3B illustrate an example of placement equipment and corresponding equipment state model according to various embodiments.

FIG. 4 illustrates an example flowchart for event messaging in a printed circuit board assembly manufacturing system according to various examples.

FIG. 5 illustrates an example line gateway communicating with a manufacturing line in a manufacturing system according to various examples.

FIG. 6 illustrates an example factory gateway communicating with a shop floor in a manufacturing system according to various examples.

FIGS. 7 and 8 illustrate an example of a computer system of the type that may be used to implement various embodiments.

### DETAILED DESCRIPTION

### Event-Driven Communication in a Manufacturing Environment

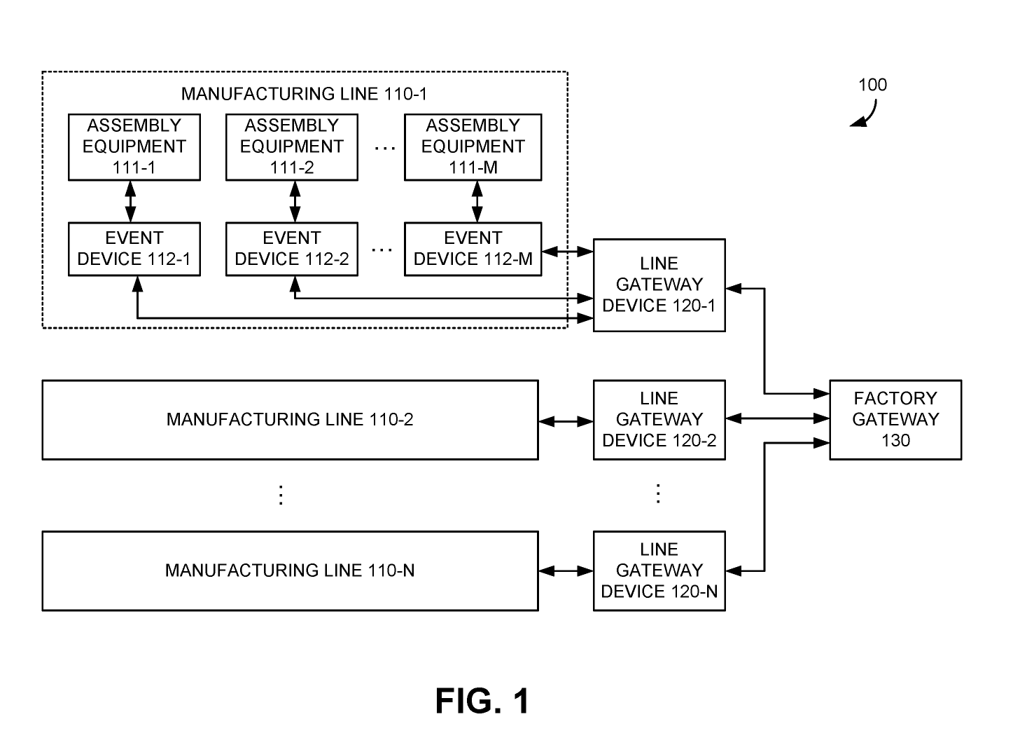

FIG. 1 illustrates an example of a manufacturing system 100 for printed circuit board assembly according to various embodiments. Referring to FIG. 1, the manufacturing system 100 can include multiple manufacturing lines 110-1 to 110-N, which include various types of equipment to at least partially automate manufacture of electronic systems, such as printed circuit board assemblies. For example, the manufacturing line 110-1 can include assembly equipment 111-1 to 111-M, each to perform at least one manufacturing or testing operation. The other manufacturing lines 110-2 to 110-N may be configured to include assembly equipment 111-1 to 111-M similar to the manufacturing line 110-1 or may be include different assembly equipment or configuration of assembly equipment to manufacture a different portion of the electronic systems, different electronic systems, or the like.

In some embodiments, the assembly equipment 111-1 to 111-M can include one or more feeder machines to provide printed circuit boards to one or more conveyors in the manufacturing line 110-1. The conveyors in the assembly equipment 111-1 to 111-M can move and route the printed circuit boards to other machines in the assembly equipment 111-1 to 111-M. For example, the conveyors can move the printed circuit boards to placement equipment, which can dispose electronic components onto the printed circuit boards. This placement equipment can utilize a programmed routine or recipe to place electronic components onto the printed circuit boards, for example, using through-hole technology, surface-mount technology (SMT), or the like. With through-hole technology, the placement equipment can place lead or pins of the electronic components in holes surrounded by conductive pads of the printed circuit boards. With surface-mount technology, the placement equipment can place the electronic components on the printed circuit board so that the pins line up with the conductive pads or lands on the surfaces of the printed circuit board. In some embodiments, the placement equipment also can solder the components to the printed circuit boards, or the conveyor can move the printed circuit boards through the manufacturing line 110-1 to a different piece of the assembly equipment 111-1 to 111-M to perform the soldering operations.

The conveyors in the assembly equipment 111-1 to 111-M also can route the printed circuit boards to visual inspection equipment or electronic verification machines in the assembly equipment 111-1 to 111-M. The visual inspection equipment can capture an image or otherwise scan the assembled printed circuit board to determine whether the placement equipment properly placed the electrical components on the printed circuit board. In some embodiments, the visual inspection equipment can detect physical locations of the placed components relative to expected locations on the underlying printed circuit boards. The visual inspection equipment also may be able to determine a height of the place components relative to expected heights on the underlying printed circuit boards. The electronic verification machines, in some examples, can electronically test connectivity of the electronic components to the printed circuit boards, to each other via one or more traces on the printed circuit boards, or the like.

The manufacturing line 110-1 can include one or more event devices 112-1 to 112-M, which can bi-directionally communicate with the assembly equipment 111-1 to 111-M. The assembly equipment 111-1 to 111-M may include external interfaces to exchange status information with the event devices 112-1 to 112-M. The event devices 112-1 to 112-M can communicate with the assembly equipment 111-1 to 111-M via one or more wired connections, wirelessly, or a combination thereof.

The status information can correspond to one or more manufacturing, inspection, or verification operations the assembly equipment 111-1 to 111-M is performing or has performed. For example, when a placement machine receives a new printed circuit board, the placement machine can output status information corresponding to the reception of the new printed circuit board and optionally include an identifier of the board, a process point in the placement machine that the board is or will be located, or the like. The placement machine also may be configured to output status information regarding a supply of electronic components it has available to place on printed circuit boards, status of manufacturing operations the placement machine has performed or is performing, or the like. The visual inspection equipment or electronic verification machines can output status information corresponding to the printed circuit board assemblies, inspections or tests performed in the printed circuit board assemblies, results of the inspections or tests, or the like.

The event devices 112-1 to 112-M can translate the status information from the assembly equipment 111-1 to 111-M, respectively, into a messages having common manufacturing language format, for example, conforming to an Open Manufacturing Language (OML) standard, or the like. In some embodiments, the event devices 112-1 to 112-M can utilize the status information to determine states of the assembly equipment 111-1 to 111-M. The event devices 112-1 to 112-M, in some embodiments, can maintain a state machine representation that models states of the assembly equipment 111-1 to 111-M, which can be updated based on the status information received from one or more pieces of the assembly equipment 111-1 to 111-M. For example, when one of the event devices 112-1 to 112-M receives status information from one of the assembly equipment 111-1 to 111-M, the event device can selectively update the state machine representation of the model for the state of the piece of assembly equipment based on the status information. Embodiments of maintaining a state machine representation of assembly equipment will be described below in greater detail.

The event device 112-1 to 112-M, in response to one or more state changes or types of received status information, may generate one or more event messages. In some embodiments, the event messages can identify a state or a change in state of at least a portion of one or more pieces of the assembly equipment 111-1 to 111-M, a status of at least one printed circuit board in the manufacturing line, or the like. The event messages may have a messaging format, such as a Java-Script Object Notation (JSON) or the like, and populated with information describing one or more events associated with the assembly equipment 111-1 to 111-M. In some embodiments, each event message can include information to describe particular action, inaction, operation, or status of a piece of the assembly equipment, while also providing context for that action, inaction, operation, or status relative to one or more past events or a current state of the assembly equipment.

An example implementation of a computing system capable of implementing one or more of the event devices 112-1 to 112-M is described below with reference to FIGS. 8 and 9. Although the event devices 112-1 to 112-M are shown in FIG. 1 as separate from the assembly equipment 111-1 to 111-M, in some embodiments, one or more of the event devices 112-1 to 112-M may be physically integrated into the assembly equipment 111-1 to 111-M or the assembly equipment 111-1 to 111-M can be modified to implement the functionality of the event devices 112-1 to 112-M. Also, even though FIG. 1 shows a one-to-one correspondence of the event devices 112-1 to 112-M to the assembly equipment 111-1 to 111-M, in some embodiments, the manufacturing lines 110-1 can include different numbers of the event devices 112-1 to 112-M and the assembly equipment 111-1 to 111-M, one or more of the event devices 112-1 to 112-M may correspond to a plurality of the manufacturing lines 110-1 to 110-N, or the like.

The manufacturing system 100 can include multiple line gateway devices 120-1 to 120-N, for example, one corresponding to each of the manufacturing lines 110-1 to 110-N. In some embodiments, a line gateway device can correspond to multiple manufacturing lines or one manufacturing line can correspond to more than one line gate gateway device. The event devices in the manufacturing lines 110-1 to 110-N, such as event devices 112-1 to 112-M, can transmit event messages to the line gateway devices 120-1 to 120-N. In some embodiments, the event devices in the manufacturing lines 110-1 to 110-N can exchange packetized messages with the line gateway devices 120-1 to 120-N utilizing a transmission protocol, such as transmission control protocol (TCP), or the like. As will be described below in greater detail, the line gateway devices 120-1 to 120-N can subscribe to receive certain types of event messages from the event devices in the manufacturing lines 110-1 to 110-N, for example, utilizing a bi-directional subscription protocol described in the OML standard.

The line gateway devices 120-1 to 120-N can utilize the event messages to identify line-specific operations for the manufacturing lines 110-1 to 110-N. For example, the line gateway devices 120-1 to 120-N can analyze event messages from multiple different pieces of assembly equipment in one of the manufacturing lines 110-1 to 110-N to determine manufacturing bottle-necks, manufacturing materials shortages, track printed circuit board assembly through the manufacturing lines110-1 to 110-N, correlate manufacturing defects to particular lanes, stations, modules, process points, and/or specific operations within one or more pieces of the assembly equipment, or the like. The line gateway devices 120-1 to 120-N, in some embodiments, generate line event messages based on the analysis of the event messages and forward them to subscribing devices, such as a factory gateway device 130.

The line gateway devices 120-1 to 120-N also can transmit equipment control messages to the event devices in the manufacturing lines 110-1 to 110-N. The event devices in the manufacturing lines 110-1 to 110-N can analyze the equipment control messages and generate control signaling utilized to direct operations by assembly equipment in the manufacturing lines 110-1 to 110-N.

The manufacturing system 100 can include a factory gateway device 130, for example, to bi-directionally communicate with the line gateway devices 120-1 to 120-N. In some embodiments, the factory gateway device 130 can exchange packetized messages with the line gateway devices 120-1 to 120-N utilizing a transmission protocol, such as transmission control protocol (TCP), or the like. The line gateway devices 120-1 to 120-N can transmit event messages and any line event messages to the factory gateway device 130. As will be described below in greater detail, the factory gateway device 130 can subscribe to receive certain types of event messages from the event devices and/or line event messages from the line gateway devices 120-1 to 120-N, for example, utilizing a bi-directional subscription protocol described in the OML standard.

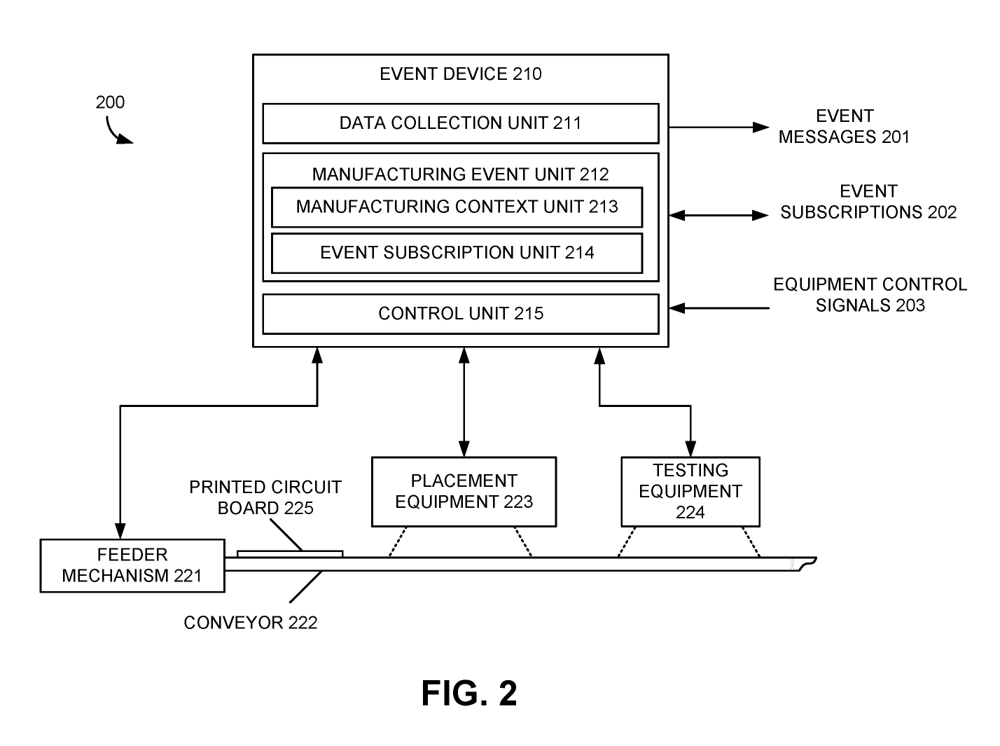

FIG. 2 illustrates an example of a portion of a manufacturing line 200 in a manufacturing system according to various embodiments. Referring to FIG. 2, the portion of the manufacturing line 200 can include various pieces of the assembly equipment to at least partially automate manufacture and testing of printed circuit board assemblies. In the instant example, the assembly equipment can include a feeder mechanism 221, a conveyor 222, placement equipment 223, and testing equipment 224.

The feeder mechanism 221 can provide a printed circuit board 225 to the conveyor 222, which can move the printed circuit board 225 to the placement equipment 223 and the testing equipment 224. The placement equipment 225 can dispose electronic components onto the printed circuit board 225. For example, the placement equipment 223 can utilize a programmed routine or recipe to place electronic components onto the printed circuit board 225, for example, using through-hole technology, surface-mount technology (SMT), or the like. The conveyor 222 can route the printed circuit board 225 from the placement equipment 223 to testing equipment 224, for example, to perform a visual inspection or an electronic verification of the assembled printed circuit board. The conveyor 222 can route the printed circuit board 225 away from the testing equipment 224 towards other portions of the manufacturing line.

The portion of the manufacturing line 200 can include an event device 210 to communicate with at least one of the feeder mechanism 221, the conveyor 222, the placement equipment 223, or the testing equipment 224. When the feeder mechanism 221, the conveyor 222, the placement equipment 223, and/or the testing equipment 224 output, via their external interfaces, status information describing their operations, the event device 210 can be configured to receive and translate the status information into one or more event messages 201, for example, conforming to the OML standard.

In some embodiments, the event device 210 can transmit the event messages 201 towards one or more gateway devices, such as a line gateway device or a factory gateway device in the manufacturing system. The gateway devices may exchange one or more event subscriptions 202 with the event device 210, which can subscribe the gateway devices to receive transmission of selectable types of the event messages 201 from the event device 210. The event subscriptions 202 may identify a subset of event messages that could be generated by the event device 210 to forward towards one or more gateway devices. The event subscriptions 202 may define the subset of the event messages by type of event message, by the piece of equipment corresponding to the event message, by printed circuit board or items being manufactured, by time of operation, or the like. The event device 210 may selectively transmit one or more of the event messages 201 towards the gateway devices based on the event subscriptions 202.

The event device 210 also may receive equipment control signals 203, for example, from the one or more gateway devices. The event device 210, based on the equipment control signals 203, can prompt the assembly equipment in the portion of the manufacturing line 200 to perform one or more operations, such as stopping, shutting-down, adjusting equipment operation, recalibration of equipment, loading new programmed routine to place electronic components onto the printed circuit boards, or the like. Although FIG. 2 shows a single event device 210 communicating with multiple different pieces of assembly equipment in the portion of the manufacturing line 200, in some embodiments, the portion of the manufacturing line 200 can include multiple event devices to communicate with the pieces of the equipment or to be included in one or more pieces of the equipment.

The event device 210 can include a data collection unit 211 to receive status information from at least one of the feeder mechanism 221, the conveyor 222, the placement equipment 223, and/or the testing equipment 224. The status information can correspond to operations performed by the assembly equipment along with identification of items being assembled, such as printed circuit boards, components, or the like. In some embodiments, the feeder mechanism 221, the conveyor 222, the placement equipment 223, and/or the testing equipment 224 may output the status information with differing standards, protocols, and methodologies, for example, proprietary to the vendors of those pieces of equipment. The data collection unit 211 can be configured to communicate with the various assembly equipment and their various standards, protocols, and methodologies to receive the status information.

The event device 210 can include a manufacturing event unit 212 to analyze the status information received from the assembly equipment and translate the status information into one or more event messages 201, for example, that conform to the OML standard. The manufacturing event unit 212 can transmit the event messages 201 towards the one or more gateway devices.

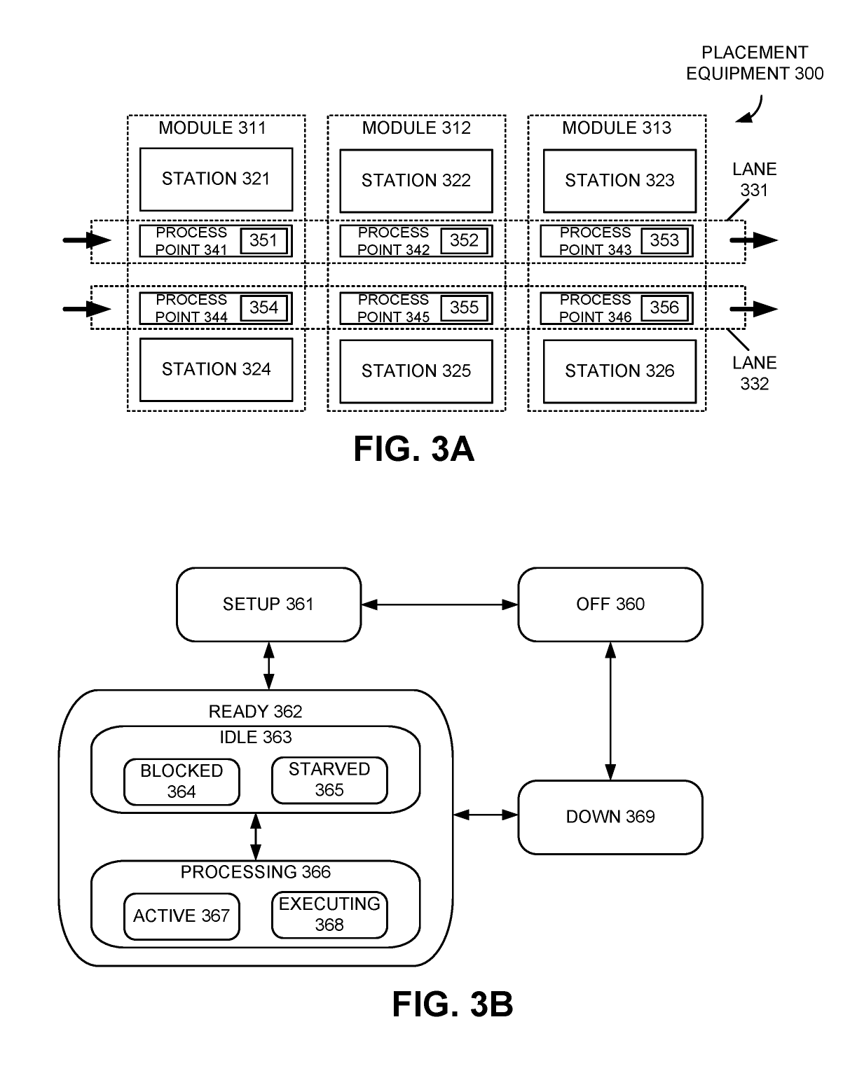

The manufacturing event unit 212 can include a manufacturing context unit 213 to determine a context for the status information received from the assembly equipment. For example, when a piece of assembly equipment can operate in multiple different states, the manufacturing context unit 213 can maintain a state machine representation of the assembly equipment based on the status information received from that piece of assembly equipment. The manufacturing context unit 213 can utilize the state machine representation of the assembly equipment to provide a context for the status information received by the event device 210. The manufacturing context unit 213 also can update the state machine representation based on received status information, for example, changing states in the state machine. An example of placement equipment and corresponding equipment state model is shown below in FIGS. 3A and 3B.

FIGS. 3A and 3B illustrate an example of placement equipment 300 and corresponding equipment state model according to various embodiments. Referring to FIG. 3A, the placement equipment 300 can perform operations, such as placement of components or soldering, on a plurality of items or printed circuit boards 351-356, respectively. The placement equipment 300 can include multiple lanes 331 and 332, each of which can allow a conveyor to move the printed circuit boards 351-356 to different process points 341-346 in the placement equipment 300. For example, the lane 331 can move the printed circuit boards 351-353 to the process points 341-343, respectively, and the lane 332 can move the printed circuit boards 354-356 to the process points 344-346.

The placement equipment 300 can include multiple modules 311-313, each corresponding to a portion for of the placement equipment having multiple stations 321-326 and corresponding process points 341-346. For example, the module 311 can include stations 321 and 324 to place components or perform other operations on the printed circuit boards 351 and 354 located in the respective process points 341 and 344. The module 312 can include stations 322 and 325 to place components or perform other operations on the printed circuit boards 352 and 355 located in the respective process points 342 and 345. The module 313 can include stations 323 and 326 to place components or perform other operations on the printed circuit boards 353 and 356 located in the respective process points 343 and 346. Each of the stations 321-326 can correspond to a different fixed location in the placement equipment 300, which can be configured to connect to at least one of a feeder, trolley, or tray server. The stations 321-326 can hold components or other supplies for the placement equipment 300 to utilize in the assembly of the printed circuit boards 351-356. The process points 341-346, in some embodiments, can be defined as the different intersections between the modules 311-313 and the lanes 331 and 332.

Referring to FIG. 3B, one or more event devices can utilize an equipment state model to represent a state of the placement equipment 300. In some embodiments, the equipment state model can correspond to an IPC standard, IPC-2541, titled “Generic Requirements for Electronics Manufacturing Shop-Floor Equipment Communication Messages (CAMX).”

The equipment state model can include multiple different states, such as off 360, setup 361, ready 362, and down 369. The off state 360 can indicate that the placement equipment 300 has been powered down and not available for production. The setup state 361 can indicate that the placement equipment 300 is being configured, which can involve a deliberate action being taken on the placement equipment 300. The ready state 363 can indicate the placement equipment 300 can perform placement operations. The down state 369 can indicate that the placement equipment 300 lacks components or other consumable material to perform operations, an equipment malfunction, host or operator intervention, equipment initiated events, or the like.

Within the ready state 362, the equipment state model can define sub-states of idle 363 and processing 366. The idle sub-state 363 can indicate the placement equipment 300 may be ready to process items. The processing state 366 can indicate the placement equipment 300 executes operation on an item, such as assembling a printed circuit board.

Within the idle sub-state 363, the equipment state model can define sub-states of blocked 364 and starved 365. The blocked sub-state 364 can indicate the placement equipment 300 has completed processing one or more items and may be blocked from sending the completed items to a downstream piece of equipment. The placement equipment 300 may be unable to accept any new items into its staging or working zones. The starved sub-state 365 can indicate the placement equipment 300 awaits receptions an item from an upstream piece of equipment. The placement equipment 300 working area may be available to process the item, but it is not being given anything to build.

Within the processing sub-state 366, the equipment state model can define sub-states of active 367 and executing 368. The active sub-state 367 can indicate the placement equipment 300 has an item available, but no recipe or programmed routine to execute. The active sub-state 367 also can include time intervals when items are transferring into or out of the placement equipment 300, or between different zones within the placement equipment 300. The executing sub-state 368 can indicate the placement equipment 300 executes a recipe or programmed routine, which can perform placement operations on the item or printed circuit board. The executing sub-state 368 also can include time intervals, such as a fiducial finding, board alignment, of the like, in the placement equipment 300.

Referring back to FIG. 2, the manufacturing context unit 213 can generate the event messages 201 based on the status information and the understanding of the context of that status information provided by the state machine representation of the assembly equipment. The event messages 201, in some embodiments, can identify a state of the assembly equipment and/or a portion of the assembly equipment corresponding to the events identified in the event messages 201. For example, the placement equipment 223 can include one or more lanes for the conveyer 222 to provide printed circuit boards, include one or more modules to place electronic components on the printed circuit boards, each module can include one or more stations that have corresponding processing points to place electronic components on the printed circuit boards. The event messages 201, depending on their message type, can identify an overall state of the placement equipment 223, a state of a lane in the placement equipment 223, a state of a module in the placement equipment 223, a state of a station in the placement equipment 223, a state of a process point in the placement equipment 223, or a combination thereof.

For example, when a process point in the placement equipment 223 provides status information that it is idle, the manufacturing context unit 213 can utilize the state machine representation of the placement equipment 223 to identify whether the placement equipment 223 is idle due to being blocked from transferring out an assembled printed circuit board 225 or starved of a new printed circuit board from an upstream piece of equipment. The manufacturing context unit 213 can generate the event messages 201 based on both the status information and the context the manufacturing context unit 213 derives from the state machine representation of the placement equipment 223. The event messages 201 can have many different types, such as those defined by the OML standard, which can include a general message, an equipment configuration message, an equipment status message, an item or printed circuit board assembly-specific message, a programmed routine message, a feeder message, a component handling message, an equipment control message, a material management message, an item or printed circuit board assembly tracing message, an identification message, a low-level message, a quality management message, an error message, a subscription and registration messages, or the like.

The manufacturing event unit 212 can include an event subscription unit 214 to exchange one or more event subscriptions 202 with the gateway devices. The exchange of the event subscriptions 202 can allow the event subscription unit 214 to subscribe the gateway devices to receive transmission of selectable types of the event messages 201 from the event device 210. The event device 210 may selectively transmit one or more of the event messages 201 towards the gateway devices based on the subscriptions determined by the event subscription unit 214. In some embodiments, the event subscription unit 214 and the gateway devices can implement a subscription protocol in the OML standard to subscribe the gateway devices to certain message types.

The event device 210 can include control unit 215 to receive equipment control signals 203, for example, from one or more of the gateway devices. The equipment control signals 203 can request the control unit 215 prompt the assembly equipment to perform one or more operations, such as stopping, shutting-down, adjusting equipment operation, recalibration of equipment, loading new programmed routine to place electronic components onto the printed circuit boards, or the like. In some embodiments, the control unit 215 and the gateway devices can communicate with a protocol described in the OML standard, which can allow the gateway devices to provide the equipment control signals 203 to the event device 210.

The control unit 215, in some embodiments, can receive the equipment control signals 203 as one or more messages and translate a requested control action in the equipment control signals 203 into a format compatible with the assembly equipment. In some embodiments, the control unit 215 can parse the equipment control signals 203 to identify the piece of assembly equipment to be controlled and the requested control action, and then generate messaging in the format for transmission to the assembly equipment, such as at least one of the feeder mechanism 221m the conveyor 222, the placement equipment 223, or the testing equipment 224. The control unit 215 can transmit the messaging to the assembly equipment, which can prompt the assembly equipment to perform the requested control action in the equipment control signals 203.

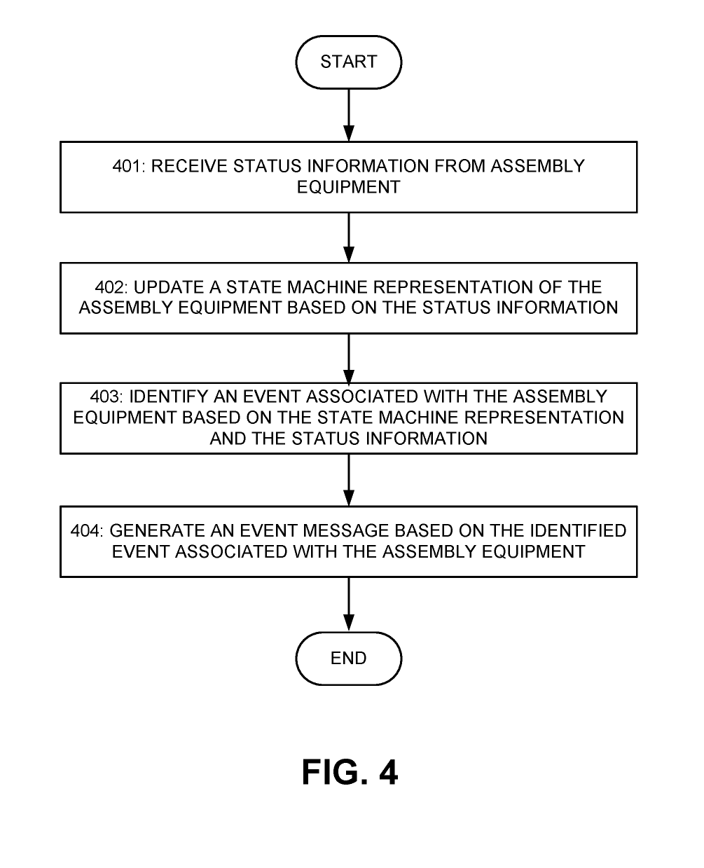

FIG. 4 illustrates an example flowchart for event messaging in a printed circuit board assembly manufacturing system according to various examples. Referring to FIG. 4, in a block 401, an event device can receive status information from assembly equipment. The status information can correspond to one or more manufacturing, inspection, or verification operations the assembly equipment is performing or has performed. For example, when a placement machine receives a new printed circuit board, the placement machine can output status information corresponding to the reception of the new printed circuit board and optionally include an identifier of the board, a process point in the placement machine that the board is or will be located, or the like. The placement machine also may be configured to output status information regarding a supply of electronic components it has available to place on printed circuit boards, status of manufacturing operations the placement machine has performed or is performing, or the like. The visual inspection equipment or electronic verification machines can output status information corresponding to the printed circuit board assemblies, inspections or tests performed in the printed circuit board assemblies, results of the inspections or tests, or the like.

In some embodiments, the assembly equipment may output the status information with varying standards, protocols, and methodologies, for example, proprietary to the vendors of the assembly equipment. The event device can be configured to communicate with the assembly equipment utilizing the various standards, protocols, and methodologies to receive the status information.

In a block 402, the event device can update a state machine representation of the assembly equipment based on the status information. The event device can maintain a state machine representation that models states of the assembly equipment. The event device can update the state machine representation of the assembly equipment based on the status information. In some embodiments, the event device can parse the status information to identify an operation or status of the assembly equipment. The event device can utilize the identified operation or status to selectively transition a state of the state machine representation modeling the assembly equipment.

In a block 403, the event device can identify an event associated with the assembly equipment based on the state machine representation and the status information. In some embodiments, the event device can identify the event directly from the status information. For example, when the status information identifies an error or malfunction in the assembly equipment, the event device can determine an error event for the assembly equipment. In some embodiments, the event device can utilize the state machine representation to identify the event associated with the assembly equipment. The event can correspond to a change in a state in the state machine representation prompted by the status information, a lack of a change in the state in the state machine representation when one is expected, or the like. The event also may be dependent on a type of state change or lack thereof. For example, when the status information indicates the assembly equipment becomes idle, the event device may determine whether to identify an event in the assembly equipment based on which previous state the assembly was in prior to becoming idle.

In a block 404, the event device can generate an event message based on the identified event associated with the assembly equipment. In some embodiments, the event message can conform to an OML protocol, which can describe a state of the assembly equipment, identify a particular items being processed by the assembly equipment, or the like. The event device can store a copy of the event message, for example, as a record of operations performed by the assembly equipment, or forward the event message to gateway device.

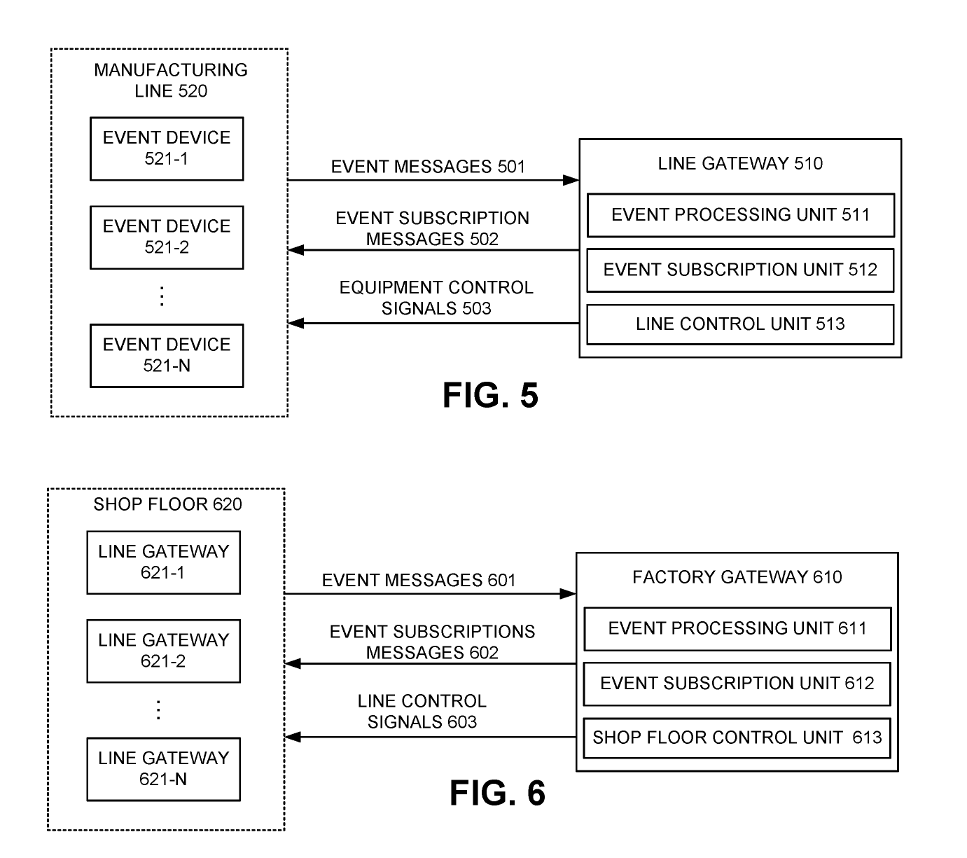

FIG. 5 illustrates an example line gateway 510 communicating with a manufacturing line 520 in a manufacturing system according to various examples. Referring to FIG. 5, the line gateway 510 can communicate with one or more event devices 521-1 to 521-N in a manufacturing line 520, for example, through an exchange of packets utilizing a transmission protocol, such as transmission control protocol (TCP), or the like. The packets can include messages configured according to the OML standard, such as event messages 501, event subscription messages 502, and equipment control signals 503. In some embodiments, the messages may have a messaging format, such as a Java-Script Object Notation (JSON) or the like, and populated with information conforming to the OML standard.

The event messages 501 from event devices 521-1 to 521-N in a manufacturing line 520 can identify events that have occurred in the assembly equipment communicatively coupled to the event devices 521-1 to 521-N. In some embodiments, the events described in the event messages 501 can correspond to the different events described in the OML standard. For example, the events can describe an operational state of assembly equipment, a change in operational state of the assembly equipment, a status of the assembly equipment, a status of items being processed by the assembly equipment, or the like.

The line gateway 510 can include an event processing unit 511 to utilize the event messages 501 to identify line-specific operations for the manufacturing line 520. For example, the event processing unit 511 can analyze event messages 501 from multiple different pieces of assembly equipment in one of the manufacturing line 520 determine manufacturing bottle-necks, manufacturing materials shortages, track printed circuit board assembly through the manufacturing line 520, correlate manufacturing defects to particular lanes, stations, modules, process points, and/or specific operations within one or more pieces of the assembly equipment, or the like. The event processing unit 511, in some embodiments, can generate line event messages based on the analysis of the event messages 501. The event processing unit 511 also may store the event messages 501 and any generated line event messages in a local storage device. The event processing unit 511 also can forward the event messages 501 and any generated line event messages to other devices, such as a factory gateway in the manufacturing system.

The line gateway 510 can include an event subscription unit 512 to subscribe to receive one or more of the event messages 501 from the event devices 521-1 to 521-N. The event subscription unit 512 can transmit event subscription messages 502 to one or more of the event devices 521-1 to 521-N. The event subscription messages 502, in some embodiments, can subscribe the line gateway 510 to receive a subset of the event messages 501 capable of being generated by the event devices 521-1 to 521-N. The event subscription messages 502 may define the subset of the event messages 501 for the event device 521-1 to 521-N to transmit to the line gateway 510 by message type, by the piece of equipment corresponding to the event messages 501, by printed circuit board or items being manufactured, by time of operation, or the like.

The event subscription unit 512 also can receive a confirmation message or acknowledgement from the event devices 521-1 to 521-N having received the event subscription messages 502. In some embodiments, the event subscription messages 502 and a corresponding confirmation message or acknowledgement from the event devices 521-1 to 521-N can implement a subscription protocol in the OML standard, which can subscribe the line gateway 510 to receive the subset of the event messages 501. The ability to subscribe to subsets of the event messages 501, for example, on message type and an event device-basis, the line gateway 510 may limit a volume of data transmitted towards the line gateway 510, which may allow for less bandwidth utilization and timely reception of the subset of the event messages 501 by the line gateway 510.

The line gateway 510 can include a line control unit 513 to transmit the equipment control signals 503 to at least one of the event devices 521-1 to 521-N in the manufacturing lines 520. The event devices 521-1 to 521-N can parse the equipment control signals 503, for example, based on the OML standard, to identify a piece of assembly equipment communicatively coupled to the event devices 521-1 to 521-N and an action for the identified piece of assembly equipment to perform. The event devices 521-1 to 521-N can generate control signaling based on the identified piece of assembly equipment and the identified action, and provide the control signaling to the identified piece of assembly equipment. The generated control signaling can be configured to prompt or direct the identified piece of assembly equipment to perform the action identified in the equipment control signals 503. In some embodiments, the action identified in the equipment control signals 503 can include shutting-down or stopping operations in the piece of assembly equipment, reconfiguring or recalibrating the piece of assembly equipment, reprogramming a recipe or routine in the piece of assembly equipment, prompting generation of a report by the assembly equipment, or the like.

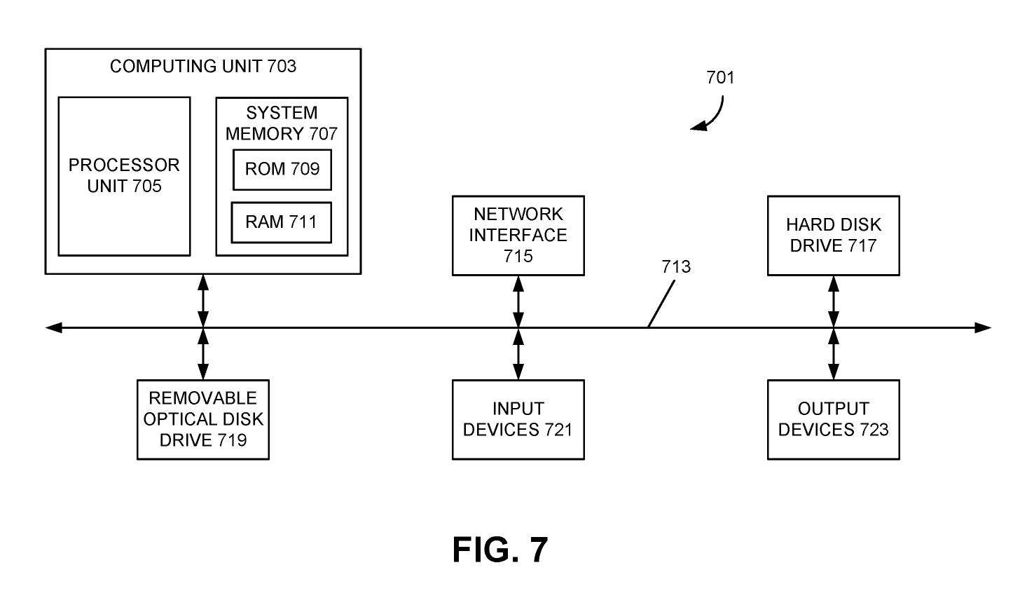

FIG. 6 illustrates an example factory gateway 610 communicating with a shop floor 620 in a manufacturing system according to various examples. Referring to FIG. 6, the factory gateway 610 can communicate with one or more line gateways 621-1 to 621-N in a shop floor 620, for example, through an exchange of packets utilizing a transmission protocol, such as transmission control protocol (TCP), or the like. The packets can include messages configured according to the OML standard, such as event messages 601, event subscription messages 602, and equipment control signals 603. In some embodiments, the messages may have a messaging format, such as a Java-Script Object Notation (JSON) or the like, and populated with information conforming to the OML standard.

The communication between factory gateway 610 and the line gateways 621-1 to 621-N can be similar to the communication described above with reference to FIG. 5 between the line gateway 510 and the event devices 521-1 to 521-N. In some instances, the line gateways 621-1 to 621-N can forward the event messages 601 they receive from event devices to the factory gateway 610

The factory gateway 610 can include an event processing unit 611 to utilize the event messages 601 to identify factory-specific operations for the shop floor 620. For example, the event processing unit 611 can analyze event messages 601 from multiple different pieces of assembly equipment across different manufacturing lines to determine manufacturing bottle-necks between the manufacturing lines, manufacturing throughput differences between the manufacturing lines, manufacturing materials shortages, track printed circuit board assembly through the manufacturing lines, correlate manufacturing defects to particular lanes, stations, modules, process points, and/or specific operations within one or more pieces of the assembly equipment, or the like.

In some embodiments, the event messages 601 can include line event messages generated by at least one of the line gateways 621-1 to 621-N, which can identify status of operations across multiple pieces of assembly equipment in the manufacturing lines. The event processing unit 611 also may store the event messages 601 and any received line event messages in a local storage device.

The line gateway 610 can include an event subscription unit 612 to subscribe to receive one or more of the event messages 601 from the line gateways 621-1 to 621-N. The event subscription unit 612 can transmit event subscription messages 602 to one or more of the line gateways 621-1 to 621-N. The event subscription messages 602, in some embodiments, can subscribe the factory gateway 610 to receive a subset of the event messages 601 capable of being generated by event devices or the line gateways 621-1 to 621-N themselves. The event subscription messages 602 may define the subset of the event messages 601 for the line gateways 621-1 to 621-N to transmit to the factory gateway 610 by message type, by a line associated with an event, by the piece of equipment corresponding to the event messages 601, by printed circuit board or items being manufactured, by time of operation, or the like.

The event subscription unit 612 also can receive a confirmation message or acknowledgement from the line gateways 621-1 to 621-N having received the event subscription messages 502. In some embodiments, the event subscription messages 602 and a corresponding confirmation message or acknowledgement from the line gateways 621-1 to 621-N can implement a subscription protocol in the OML standard, which can subscribe the factory gateway to receive the subset of the event messages 601. The ability to subscribe to subsets of the event messages 601, for example, on message type, by line, or by event device, the factory gateway 610 may limit a volume of data transmitted, which may allow for less bandwidth utilization and timely reception of the subset of the event messages 601 by the factory gateway 610.

The line gateway 610 can include a shop floor control unit 613 to transmit the equipment control signals 603 to at least one of the line gateways 621-1 to 621-N. When the equipment control signals 603 identify an event device to receive the equipment control signals 603, the line gateways 621-1 to 621-N may forward the equipment control signals to the identified event device. In some embodiments, the line gateways 621-1 to 621-N can parse the equipment control signals 603, for example, based on the OML standard, to determine a piece of assembly equipment in the manufacturing line to perform a control action. The line gateways 621-1 to 621-N can identify at least one event device communicatively coupled to the determined piece of equipment, and forward the equipment control signals 603 to the identified event device.

The event device receiving the equipment control signals 603 can generate control signaling based on the piece of assembly equipment and the control action identified in the equipment control signals 603. The event device may provide the control signaling to the identified piece of assembly equipment. The generated control signaling can be configured to prompt or direct the identified piece of assembly equipment to perform the action identified in the equipment control signals 603. In some embodiments, the action identified in the equipment control signals 603 can include shutting-down or stopping operations in the piece of assembly equipment, reconfiguring or recalibrating the piece of assembly equipment, reprogramming a recipe or routine in the piece of assembly equipment, prompting generation of a report by the assembly equipment, or the like.

### Illustrative Operating Environment

The execution of various low-level sensor fusion and driving automation processes according to embodiments may be implemented using computer-executable software instructions executed by one or more programmable computing devices. Because these embodiments may be implemented using software instructions, the components and operation of a programmable computer system on which various embodiments may be employed will be described below.

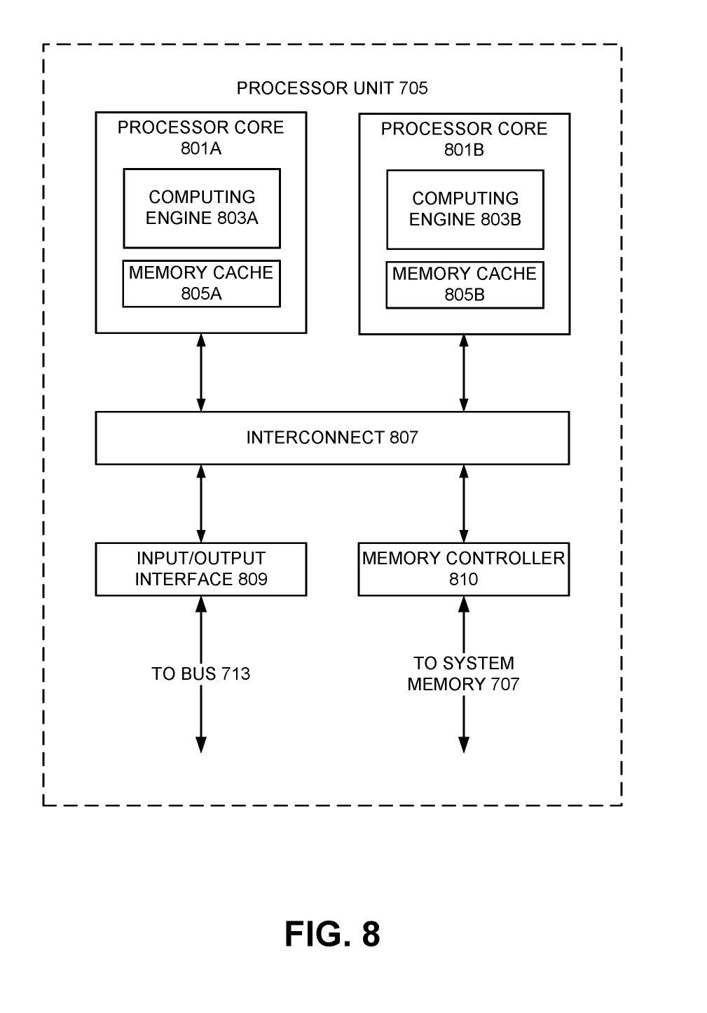

FIGS. 7 and 8 illustrate an example of a computer system of the type that may be used to implement various embodiments. Referring to FIG. 7, various examples may be implemented through the execution of software instructions by a computing device 701, such as a programmable computer. Accordingly, FIG. 7 shows an illustrative example of a computing device 701. As seen in FIG. 7, the computing device 701 includes a computing unit 703 with a processing unit 705 and a system memory 707. The processing unit 705 may be any type of programmable electronic device for executing software instructions, but will conventionally be a microprocessor. The system memory 707 may include both a read-only memory (ROM) 709 and a random access memory (RAM) 711. As will be appreciated by those of ordinary skill in the art, both the read-only memory (ROM) 709 and the random access memory (RAM) 711 may store software instructions for execution by the processing unit 705.

The processing unit 705 and the system memory 707 are connected, either directly or indirectly, through a bus 713 or alternate communication structure, to one or more peripheral devices 717-723. For example, the processing unit 705 or the system memory 707 may be directly or indirectly connected to one or more additional memory storage devices, such as a hard disk drive 717, which can be magnetic and/or removable, a removable optical disk drive 719, and/or a flash memory card. The processing unit 705 and the system memory 707 also may be directly or indirectly connected to one or more input devices 721 and one or more output devices 723. The input devices 721 may include, for example, a keyboard, a pointing device (such as a mouse, touchpad, stylus, trackball, or joystick), a scanner, a camera, and a microphone. The output devices 723 may include, for example, a monitor display, a printer and speakers. With various examples of the computing device 701, one or more of the peripheral devices 717-723 may be internally housed with the computing unit 703. Alternately, one or more of the peripheral devices 717-723 may be external to the housing for the computing unit 703 and connected to the bus 713 through, for example, a Universal Serial Bus (USB) connection.

With some implementations, the computing unit 703 may be directly or indirectly connected to a network interface 715 for communicating with other devices making up a network. The network interface 715 can translate data and control signals from the computing unit 703 into network messages according to one or more communication protocols, such as the transmission control protocol (TCP) and the Internet protocol (IP). Also, the network interface 715 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 701 is illustrated as an example only, and it not intended to be limiting. Various embodiments may be implemented using one or more computing devices that include the components of the computing device 701 illustrated in FIG. 7, which include only a subset of the components illustrated in FIG. 7, or which include an alternate combination of components, including components that are not shown in FIG. 7. For example, various embodiments may be implemented using a multi-processor computer, a plurality of single and/or multiprocessor computers arranged into a network, or some combination of both.

With some implementations, the processor unit 705 can have more than one processor core. Accordingly, FIG. 8 illustrates an example of a multi-core processor unit 705 that may be employed with various embodiments. As seen in this figure, the processor unit 705 includes a plurality of processor cores 801A and 801B. Each processor core 801A and 801B includes a computing engine 803A and 803B, respectively, and a memory cache 805A and 805B, respectively. As known to those of ordinary skill in the art, a computing engine 803A and 803B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 803A and 803B may then use its corresponding memory cache 805A and 805B, respectively, to quickly store and retrieve data and/or instructions for execution.

Each processor core 801A and 801B is connected to an interconnect 807. The particular construction of the interconnect 807 may vary depending upon the architecture of the processor unit 705. With some processor cores 801A and 801B, such as the Cell microprocessor created by Sony Corporation, Toshiba Corporation and IBM Corporation, the interconnect 807 may be implemented as an interconnect bus. With other processor units 801A and 801B, however, such as the Opteron™ and Athlon™ dual-core processors available from Advanced Micro Devices of Sunnyvale, Calif., the interconnect 807 may be implemented as a system request interface device. In any case, the processor cores 801A and 801B communicate through the interconnect 807 with an input/output interface 809 and a memory controller 810. The input/output interface 809 provides a communication interface between the processor unit 705 and the bus 713. Similarly, the memory controller 810 controls the exchange of information between the processor unit 705 and the system memory 707. With some implementations, the processor unit 705 may include additional components, such as a high-level cache memory accessible shared by the processor cores 801A and 801B. It also should be appreciated that the description of the computer network illustrated in FIG. 7 and FIG. 8 is provided as an example only, and it not intended to suggest any limitation as to the scope of use or functionality of alternate embodiments.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### Conclusion

While the application describes specific examples of carrying out embodiments of the invention, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
receiving, by an event device, status information from equipment configured to manufacture at least a portion of an electronic system on a printed circuit board;
determining, by the event device, an operational state of the equipment based, at least in part, on the status information and a previous operational state of the equipment; and
generating, by the event device, an event message configured to identify the operational state of the equipment.

2. The method of claim 1, further comprising:
maintaining, by the event device, a state machine representation of the equipment, which is configured to identify the previous operational state of the equipment; and
updating, by the event device, the state machine representation of the equipment based on the status information, wherein the updated state machine representation is configured to identify the operational state of the equipment.

3. The method of claim 1, further comprising:
receiving, by the event device, an event subscription from a gateway device, wherein the event subscription is configured to identify at least one event message type; and
selectively transmitting, by the event device, the event message towards the gateway device when the event message has a type corresponding the event message type identified in the event subscription.

4. The method of claim 3, further comprising:
receiving, by the event device, an equipment control signal from the gateway device, wherein the equipment control signal is configured to identify an action for the equipment to perform; and
prompting, by the event device, the equipment to perform the action in response to the equipment control signal.

5. The method of claim 1, wherein the status information is configured to provide information corresponding to materials or components utilized by the equipment to manufacture the electronic system, and further comprising generating, by the event device, another event message configured to report a status of the materials or components.

6. The method of claim 1, wherein the status information includes at least one of information corresponding to an operation performed by the equipment or the manufacture of the electronic system.

7. The method of claim 1, wherein the equipment corresponds to at least one of placement equipment, test equipment, conveyor, or a feeder mechanism.

8. An apparatus comprising at least one memory device storing instructions configured to cause one or more processing devices to perform operations comprising:
receiving status information from equipment configured to manufacture at least a portion of an electronic system on a printed circuit board;
determining an operational state of the equipment based, at least in part, on the status information and a previous operational state of the equipment; and
generating an event message configured to identify the operational state of the equipment.

9. The apparatus of claim 8, wherein the instructions are further configured to cause the one or more processing devices to perform operations comprising:
maintaining a state machine representation of the equipment, which is configured to identify the previous operational state of the equipment; and
updating the state machine representation of the equipment based on the status information, wherein the updated state machine representation is configured to identify the operational state of the equipment.

10. The apparatus of claim 8, wherein the instructions are further configured to cause the one or more processing devices to perform operations comprising:
receiving an event subscription from a gateway device, wherein the event subscription is configured to identify at least one event message type; and
selectively transmitting the event message towards the gateway device when the event message has a type corresponding the event message type identified in the event subscription.

11. The apparatus of claim 10, wherein the instructions are further configured to cause the one or more processing devices to perform operations comprising:
receiving an equipment control signal from the gateway device, wherein the equipment control signal is configured to identify an action for the equipment to perform; and
prompting the equipment to perform the action in response to the equipment control signal.

12. The apparatus of claim 8, wherein the status information is configured to provide information corresponding to materials or components utilized by the equipment to manufacture the electronic system, and wherein the instructions are further configured to cause the one or more processing devices to perform operations comprising generating another event message configured to report a status of the materials or components.

13. The apparatus of claim 8, wherein the status information includes at least one of information corresponding to an operation performed by the equipment or the manufacture of the electronic system.

14. The apparatus of claim 8, wherein the equipment corresponds to at least one of placement equipment, test equipment, conveyor, or a feeder mechanism.

15. A system comprising:
a memory device configured to store machine-readable instructions; and
a computing system including one or more processing devices, in response to executing the machine-readable instructions, configured to:
receive status information from equipment configured to manufacture at least a portion of an electronic system on a printed circuit board;
determine an operational state of the equipment based, at least in part, on the status information and a previous operational state of the equipment; and
generate an event message configured to identify the operational state of the equipment.

16. The system of claim 15, wherein the one or more processing devices, in response to executing the machine-readable instructions, are configured to
maintain a state machine representation of the equipment, which is configured to identify the previous operational state of the equipment; and
update the state machine representation of the equipment based on the status information, wherein the updated state machine representation is configured to identify the operational state of the equipment.

17. The system of claim 15, wherein the one or more processing devices, in response to executing the
receive an event subscription from a gateway device, wherein the event subscription is configured to identify at least one event message type; and
selectively transmit the event message towards the gateway device when the event message has a type corresponding the event message type identified in the event subscription.

18. The system of claim 17, wherein the one or more processing devices, in response to executing the machine-readable instructions, are configured to:
receive an equipment control signal from the gateway device, wherein the equipment control signal is configured to identify an action for the equipment to perform; and
prompt the equipment to perform the action in response to the equipment control signal.

19. The system of claim 15, wherein the status information is configured to provide information corresponding to materials or components utilized by the equipment to manufacture the electronic system, and wherein the one or more processing devices, in response to executing the machine-readable instructions, are configured to generate another event message configured to report a status of the materials or components.

20. The system of claim 15, wherein the status information includes at least one of information corresponding to an operation performed by the equipment or the manufacture of the electronic system.
